(19) United States
(12) Patent Application Publication
(10) Pub. No.: US 2011/0199761 A1
(43) Pub. Date: Aug. 18, 2011

(54) LIGHT FIXTURE

(76) Inventor: Juergen Schuler, Villingen-Schwenningen (DE)

(21) Appl. No.: 13/059,628

(22) PCT Filed: Sep. 4, 2009
(86) PCT No.: PCT/EP2009/006419

§ 371 Date: Mar. 23, 2011

(30) Foreign Application Priority Data
Nov. 7, 2008 (DE) 20 2008 014 799.9

(51) Int. Cl. F21S 4/00; F21V 1/02

(52) U.S. Cl. 362/225; 362/235

(57) ABSTRACT

A Lighting fixture having a luminaire body which supports the lamps, preferably fluorescent lamps, and has a transparent panel mounted on its light outlet side by means of a panel frame, wherein the panel frame is attached to the luminaire body such that it can be removed and replaced.

### CROSS REFERENCE TO RELATED APPLICATIONS

This application claims priority from German Patent Application Serial No. 20 2008 014 799.9, filed Nov. 7, 2009, the entire contents of which is herein incorporated fully by reference.

### BACKGROUND OF THE INVENTION

1. Field of the Invention

The present invention relates to a light fixture with a light chassis which supports the lamps, preferably fluorescent lamps. More specifically, the present invention relates to a light fixture with a light chassis which supports the lamps, and on the light exit side of which a transparent shade is affixed by means of a shade frame.

2. Description of the Related Art

The related art involves lighting fixtures having a light head. A light head can be part of a floor standard lamp, but also of a ceiling, wall, or table lamp. In order to cater the various preferences of customers in terms of designs, manufacturers are required to hold a large inventory of different design light fixtures.

What is not appreciated by the prior art is the cost and inconvenience of holding a large inventory of different design light fixtures. Accordingly, there is a need for an improved means to simplify the manufacture of the different designs of light fixtures; and, thus make them less costly.

One aspect of the present invention, therefore, is to simplify the manufacture of the different designs of light fixtures and thus make them less costly. The design of such a light head is especially characterized by the design of the light fixture frame.

### ASPECTS AND SUMMARY OF THE INVENTION

In order to cater to the various preferences of customers in terms of designs, manufacturers are required to hold a large inventory of different design light fixtures. Therefore, an aspect of the present invention is to provide a means to simplify the manufacture of the different designs of light fixtures; and, thus make them less costly.

This problem is solved by a light fixture with a light chassis which supports the lamps, and on the light exit side of which a transparent shade is affixed by means of a shade frame. The shade frame of the light fixture is attached to the light chassis so that it can be easily removed and replaced by means of a detent mechanism.

The detent mechanism can have deflectable locking levers arranged on the light chassis that engage into the shade frame from below by means of latch lugs to fix it into its position of use. Such locking levers can either be pivoted on the light chassis, or can consist of an elastic ductile material themselves, so that they can be firmly attached to the light chassis.

In addition to the latches that fix the shade frame into its position of use, intermediate latches are proposed, which keep the shade frame in an intermediate position, so that it cannot be dropped accidentally and damaged as a result.

The intermediate latches can be provided in addition to the previously mentioned latch lugs on the locking lever. Additional locking levers are provided to which the intermediate latches are attached. These locking levers are also arranged on the light chassis so that they can be deflected, preferably by pivoting. Such locking levers can be provided at least on one side or, in the alternative, be provided on opposite sides of the light chassis.

The shade frame is suspended on one side with locking levers, and on the side of the light chassis that is opposite the locking levers is suspended, so it can be pivoted and is also detachable.

The locking levers are provided with actuators that are accessible from the outside for easy operation.

In order to latch the shade frame, it is provided with latches on the side facing the locking levers that are assigned to the latch lugs of the locking levers. Such latches can preferably consist of a cross member that protrudes to the inside and has an edge lip.

The above, and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a perspective illustration of a floor standard lamp designed as taught by the present invention.

FIG. 2 is a perspective illustration of the floor standard lamp according to FIG. 1 with a hinged-out shade frame.

FIG. 3 is an enlarged sectional detail view of the light head with the shade frame in the engaged position in the vicinity of the locking lever 11.

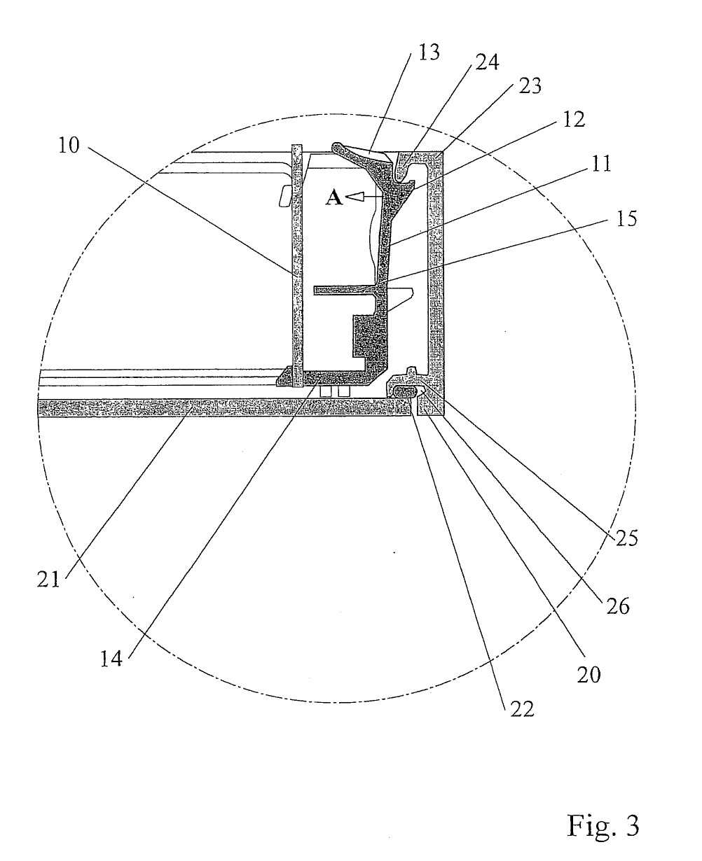

FIG. 4 is a sectional view according to FIG. 3 in the vicinity of the locking lever 16 with the shade frame in the disengaged position.

FIG. 5 is a sectional view according to FIG. 4 with the hinged-out shade frame.

FIG. 6 is a sectional view according to FIG. 3 with a varied shade frame.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

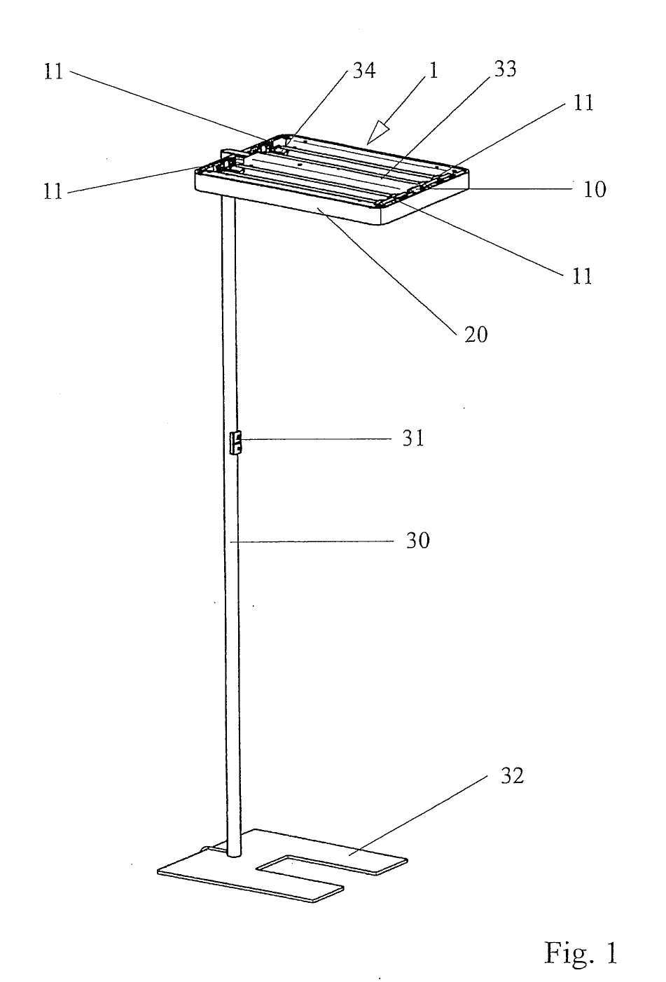

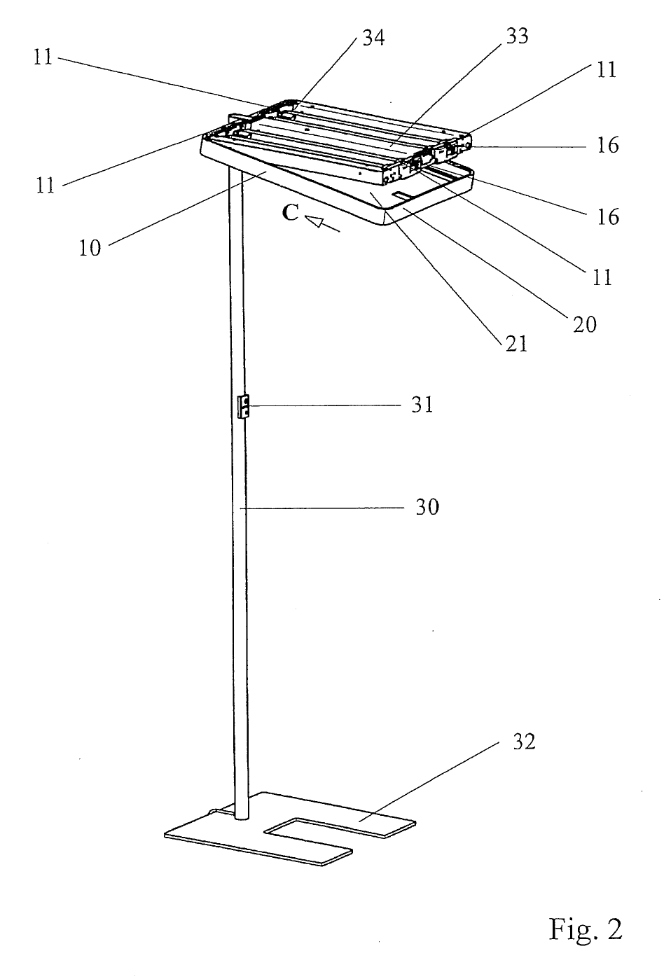

The solution as taught by the invention is explained by means of the floor standard lamp that is completely illustrated in FIGS. 1 and 2, which, as is known, consists of a light head 1 that is supported by a pillar stand 30 which for its part rests with a base 32 on the floor.

The light head 1 consists essentially of a light chassis 10, on which fluorescent lamps 33 are attached by means of lamp sockets 34. The fluorescent lamps 33 can be switched on and off with a switch 31 that is fitted at half of the height of the pillar stand 30.

The light chassis 10 is surrounded by a shade frame 20, which, as is shown in the subsequent Figures, has a transparent shade 21 that covers the lower side of the light head 1.

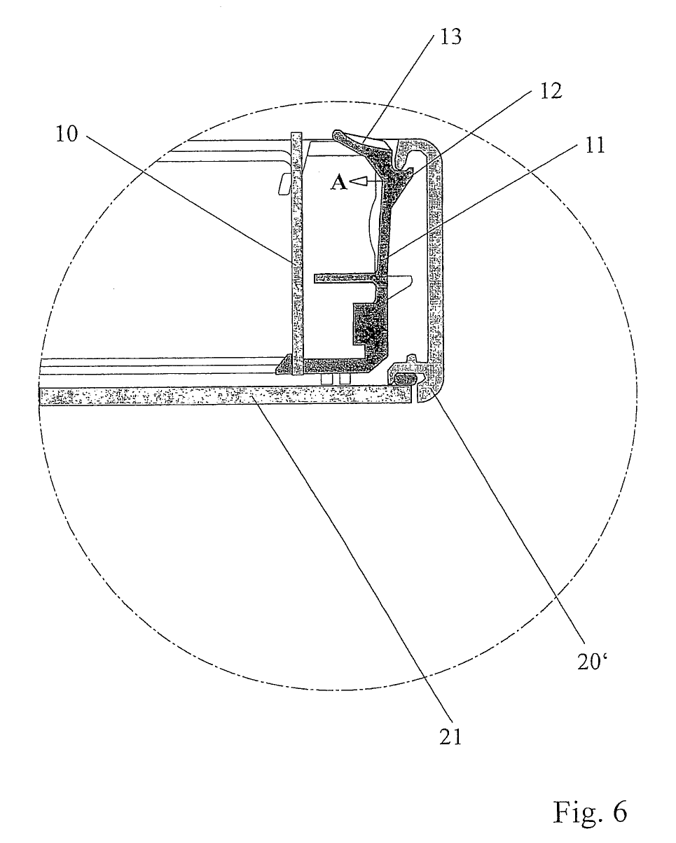

The shade frame 20 can be hinged out into the position illustrated in FIG. 2 after loosening the locking levers 11 that are holding the frame and can after shifting it a little in the direction of the arrow C, be removed completely. As a result, the owner can then replace this shade frame 20 with differently shaped frames if so desired, for instance with a frame that has rounded edges such as illustrated in FIG. 6.

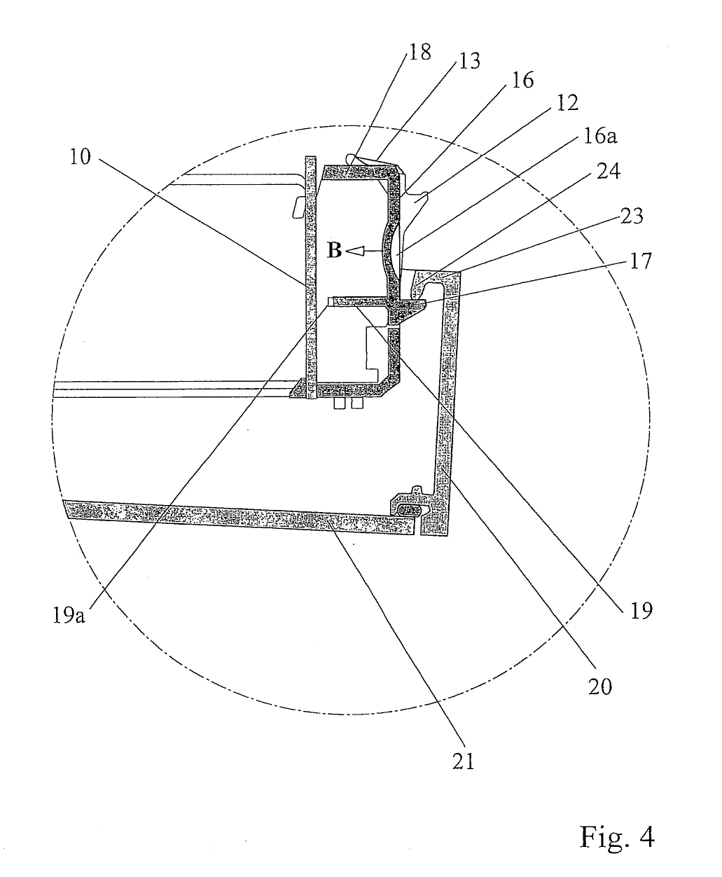

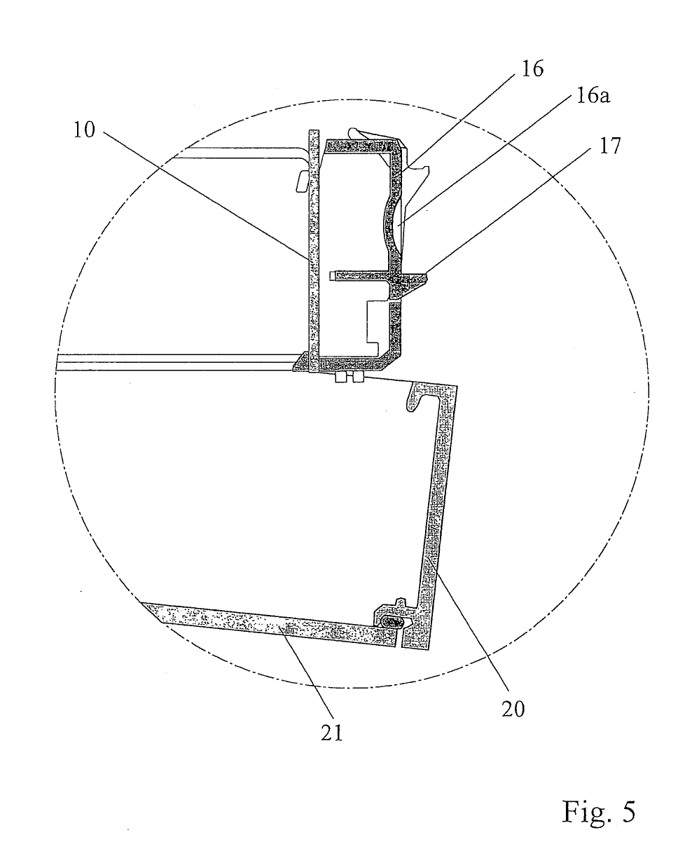

The detent mechanism for fixing the shade frame 20 is illustrated and explained in detail in the enlarged sectional views pursuant to FIGS. 4-6.

This detent mechanism consists of locking levers 11 that are attached on one front face of the light chassis 10, on the latch lugs 12 of which the shade frame 20 rests with an edge lip 24 that is facing down and is arranged on the upper cross member 23. In the embodiment that is illustrated here, the locking lever 11 that is made of an elastic plastic is attached on the chassis 10 with a support arm 14. Its upper free end projects with an actuator 13 slightly from the upper side of the light chassis 10. The locking lever can be deflected in the direction of the arrow “A” by means of this actuator 13 against the chassis 10, so that its latch lug 12 is disengaged with the edge lip 24 of the shade frame 20. In this manner, the shade frame 20, on the lower cross members of which the transparent shade 21 is attached with a seal 22 inserted between, can be swung out towards the bottom.

In order to make it easier to replace the shade frame 20 with the shade 21 and keep it in an intermediate position, further locking levers 16 are provided laterally offset to the locking levers 11 on the light chassis, on which the shade frame 20 rests with its edge lip 24 in the direction of the protruding latch lugs 17 of the shade frame 20. These locking ribs 16 also consist of elastically flexible plastic and on their upper ends are fixed with support arms 18 on the light chassis 10, while their lower ends can be pivoted in the direction of the arrow B when the locking lever 16 is pressed, so that their latch lugs 17 are disengaged with the edge lip 24 of the shade frame 20.

In order to secure the position of the locking lever 16, it is fitted with a guide arm 19 that is guided in a guide slot 19a of the light chassis 10. The locking levers 11 are also fitted in a corresponding manner with guide arms 15.

Above the latch lug 17, the locking lever 16 is provided with a recess 16a which serves as a finger seat.

After pushing the locking lever 16 in the direction of the arrow “B”, the shade frame 20 can be completely swung out towards the bottom, and as already mentioned in context with FIG. 2, be replaced with a differently shaped shade frame 20′ that is illustrated in FIG. 6.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

1-10. (canceled)

11. A light fixture with a light chassis, said light chassis supporting a set of one or more lamps, on the light exit side of which a transparent shade is affixed by means of a shade frame, and wherein said shade frame is attached on said light chassis so that it can be removed and replaced by means of a detent mechanism.

12. A light fixture according to claim 11, wherein said detent mechanism has a first set of deflectable locking levers arranged on said light chassis that engage into said shade frame from below by means of a first set of latch lugs to fix said shade frame into its position of use.

13. A light fixture according to claim 12, wherein in addition to said set of latch lugs holding said shade frame in said position of use, a set of intermediate latches is provided, which keep said shade frame in an intermediate position.

14. A light fixture according to claim 13, wherein said set of intermediate latches is provided in the form of a second set of latch lugs on a set of additional locking levers, which are arranged on said light chassis so that they can be deflected.

15. A light fixture according to claim 14, wherein said set of additional locking levers, which are arranged on said light chassis, are pivotably deflected.

16. A light fixture according to claim 14, wherein said first set of deflectable locking levers and said set of additional locking levers are arranged on at least one side of said light chassis.

17. A light fixture according to claim 14, wherein said first set of deflectable locking levers and said set of additional locking levers are arranged on opposite sides of said light chassis.

18. A light fixture according to claim 16, wherein said shade frame on the side of said light chassis that is opposite said first set of deflectable locking levers and said set of additional locking levers is suspended so as to be pivotable and detachable.

19. A light fixture according to one of claim 14, wherein said first set of deflectable locking levers has a set of corresponding actuators that are accessible from outside said light fixture.

20. A light fixture according to claim 14, wherein said shade frame has assigned latches at least on the side facing the latch lugs of said first set of deflectable locking levers and said set of additional locking levers, which said assigned latches preferably have a cross member that protrudes towards the inside and have an edge lip.

21. A light fixture according to claim 14, characterized in that said first set of deflectable locking levers and said set of additional locking levers consist of an elastic ductile material, preferably flexible plastic, and are firmly connected with one of their ends to the light chassis, while the latch lugs are provided on the free ends.

22. A light fixture according to claim 11, wherein said set of one or more lamps are fluorescent lamps.

23. A light fixture, said light fixture comprising:
(a) a light chassis which supports a set of one or more lamps;
(b) a transparent shade affixed by means of a shade frame, said shade frame being located on the light exit side of said light fixture;
(c) a detent mechanism, wherein said shade frame is attached on said light chassis so that it can be removed and replaced by means of said detent mechanism, said detent mechanism further comprising:
(i) a first set of deflectable locking levers arranged on said light chassis that engage into said shade frame from below by means of a first set of latch lugs to fix said shade frame into its position of use; and
(ii) a set of intermediate latch lugs, wherein said set of intermediate latch lugs are for keeping said shade frame in an intermediate position.

24. A light fixture according to claim 23, wherein said lamps are fluorescent lamps.

25. A light fixture according to claim 23, wherein said set of intermediate latches is provided in the form of a second set of latch lugs on a set of additional locking levers, which are arranged on said light chassis so that they can be deflected.

26. A light fixture according to claim 23, wherein said first set of deflectable locking levers has a set of corresponding actuators that are accessible from outside said light fixture.

27. A light fixture, said light fixture comprising:
(d) a light chassis which supports a set of one or more lamps;
(e) a shade frame, supporting a transparent shade located on the light exit side of said light fixture;
(f) a detent mechanism, wherein said shade frame is attached on said light chassis so that it can be removed and replaced by means of said detent mechanism, said detent mechanism further comprising:
(i) a first set of deflectable locking levers arranged on said light chassis that engage into said shade frame from below by means of a first set of latch lugs to fix said shade frame into its position of use; and
(ii) a set of intermediate latch lugs, wherein said set of intermediate latch lugs are for keeping said shade frame in an intermediate position.

28. A light fixture according to claim 27, wherein said set of intermediate latches comprises a second set of latch lugs on a set of additional locking levers, which are arranged on said light chassis so that they can be deflected.

29. A light fixture according to claim 27, wherein said shade frame has assigned latches at least on the side facing the latch lugs of said first set of deflectable locking levers and said set of additional locking levers, which said assigned latches preferably have a cross member that protrudes towards the inside and have an edge lip.

30. A light fixture according to claim 29, wherein to secure the position of each of said first set of deflectable locking levers and said set of additional locking levers, each is fitted with a guide arm that is guided in a guide slot of said light chassis; and, wherein each of said set of additional locking levers is provided, above said latch lug, with a recess which serves as a finger seat.
